(19) United States
(12) Patent Application Publication
(10) Pub. No.: US 2014/0364057 A1
(43) Pub. Date: Dec. 11, 2014

(54) DEVICE AND METHOD FOR TRANSMITTING AN INFORMATION ITEM FROM A BATTERY CELL AND BATTERY CELL

(71) Applicant: Robert Bosch GmbH, Stuttgart (DE)

(72) Inventors: Bernd Schumann, Rutesheim (DE); Fabian Henrici, Stuttgart (DE)

(21) Appl. No.: 14/364,104

(22) PCT Filed: Nov. 15, 2012
(86) PCT No.: PCT/EP2012/072681

§ 371 Date: Jun. 10, 2014

(30) Foreign Application Priority Data
Dec. 14, 2011 (DE) 10 2011 088 530.7

(51) Int. Cl. H04B 5/00

(52) U.S. Cl. CPC H04B 5/0075; H04B 5/0012
USPC 455/41.1

(57) ABSTRACT

A device for transmitting an information item from a battery cell has a first transformer and a second transformer. The first transformer is arranged on an interior side of an outside shell of the battery cell. The first transformer is configured to emit a signal representing the information through the outside shell. The second transformer is arranged on an exterior side of the outside shell and is electrically isolated from the first transformer. The second transformer is configured to pick-up the signal in order to transmit the information from the battery cell.

### PRIOR ART

The present invention relates to a device for transmitting an information item from a battery cell, to a battery cell for storing electrical energy, and to a method for transmitting an information item from a battery cell.

DE 10 2007 021 921 A1 describes a device for monitoring a battery store.

### DISCLOSURE OF THE INVENTION

On this basis, the present invention presents a device for transmitting an information item from a battery cell, a battery cell for storing electrical energy, and a method for transmitting an information item from a battery cell according to the main claims. Advantageous embodiments will become clear from the respective dependent claims and the following description.

An electronics unit, for example in the form of a sensor, can be arranged in a battery cell and can communicate with a further electronics system arranged outside the battery cell. To this end, a transmission of a signal through a battery wall into the battery or out from the battery is necessary. If the signal is transmitted directly through the battery wall, that is to say without a line being guided through the battery wall for the transmission of the signal, it is possible to dispense with a hole in the battery wall. There is thus no risk that the battery will not be tight. It is also possible to dispense with costly feedthroughs through the cell wall of the battery. Production costs for the battery cell can thus be lowered, and the tightness of the battery can be improved.

A device for transmitting an information item from a battery cell has the following features:
a first transmitter, which is arranged on an inner side of an outer shell of the battery cell, wherein the first transmitter is designed to emit a signal representing the information item through the outer shell; and
a second transmitter, which is arranged on an outer side of the outer shell and is galvanically isolated from the first transmitter, wherein the second transmitter is designed to pick up the signal.

A transmitter can be understood to be an emitter or a receiver or an emitting/receiving device. The first transmitter and the second transmitter may be formed identically. An outer shell may be a delimitation of the battery cell. The outer shell may surround the battery cell fully. The outer shell may be an outer wall of the battery cell. An information item may represent data that for example is detected inside the battery cell and is to be transmitted to a device arranged outside the battery cell. By way of example, the information item may represent a measured value of a sensor arranged in the battery cell. The information item may also reflect an operating state of the battery cell. By way of example, the information item may comprise values of a temperature sensor, a voltage measuring device or a chemical analytics sensor. The second transmitter may comprise a corresponding sensor or may be coupled to a corresponding sensor. The information item can be converted into the signal with use of a communication protocol. The transmitters can be fastened directly on the outer shell. The transmitters can be arranged opposite one another in a portion of the outer shell. The term galvanically isolated can be understood to mean that the transmitters are not interconnected via an electrical line. In particular, the first transmitter is designed to emit the signal wirelessly. The information item can thus be transmitted into the battery cell without the need for a through-hole in the outer shell, through which a signal line running between the transmitters is guided. The transmitters can be electrically insulated with respect to the outer shell.

The second transmitter can be designed to emit a further signal, representing a further information item, through the outer shell. The first transmitter can be designed to pick up the further signal. The further information item can thus be transmitted into the battery cell. A further information item may be, for example, a control command for the first transmitter or for a sensor in the battery cell. A bidirectional communication is thus possible via the transmitters.

The first transmitter can be arranged directly on the outer shell. Alternatively or additionally, the second transmitter can be arranged directly on the outer shell. Due to a direct arrangement of the transmitters on the outer shell, the signal can be sent through the outer shell with low losses. The outer shell can also serve as a mechanical support.

The first transmitter may have a first transmission region directed to the outer shell. The second transmitter can be arranged within the first transmission region. Alternatively or additionally, the second transmitter may have a second transmission region directed to the outer shell. The first transmitter may be arranged within the second transmission region. The transmitters may have a directional characteristic in order to transmit the signal through the outer shell in a targeted manner. The transmitters may be arranged opposite one another on the outer shell.

The first transmitter and the second transmitter may each be formed as an inductive transmitter. At least one of the transmitters can be formed as a coil. The other transmitter can be formed as a dipole or coil. The second transmitter may also be formed as part of a cable. A number of information items from a number of battery cells can then be picked up using one cable. The signals may be coded.

The first transmitter and the second transmitter may each be formed as a capacitive transmitter. Each transmitter may be a plate of a plate capacitor. A charge transfer in the first transmitter may cause a charge transfer in the second transmitter, and vice versa.

A battery cell for storing electrical energy has the following features:
an outer shell, which surrounds the battery cell; and
a transmission device, which is arranged on the outer shell.

The outer shell may be a metal wall, for example. The outer shell may also be made of plastic. Electrical terminals of the battery cell can be guided through the outer shell. The battery cell may be used, for example, in a vehicle as part of a rechargeable battery.

The outer shell may have a rupture membrane. In this case the device can be arranged in the region of the rupture membrane. A rupture membrane can be plastically deformed as a result of a volume change within the battery cell. If a predetermined volume change is exceeded, the rupture membrane may fail in a controlled manner, and the adjacent outer wall of the battery can thus be protected against damage. The rupture membrane may have a lower resistance than the adjacent outer wall. An outer wall of the battery cell may thus consist of a first wall material, in which a recess with the rupture membrane made of a second wall material is arranged. In this case, the outer shell is formed from an outer wall that has a recess spanned by the rupture membrane.

The outer shell may be electrically insulating in the region of the device. Electrically insulating material cannot interfere with a transmission between the transmitters, or can only interfere with this transmission to a small extent. The signal can be transmitted directly and in an unaltered manner as a result of electrically insulating material, such as plastic or ceramic.

The outer shell may be electrically conductive in the region of the device. The outer shell can interact with the signal and for example can reverse a pulse orientation of the signal. The outer shell can be electrically insulated from the first transmitter and the second transmitter, for example such that a charge transfer in the first transmitter can lead to charge transfers in the outer shell and therefore to charge transfers in the second transmitter. The first transmitter can also induce eddy currents in the outer shell, which in turn induce a current in the second transmitter.

A method for transmitting an information item from a battery cell has the following steps:
emitting a signal representing the information item by means of a first transmitter arranged on an inner side of an outer shell of the battery cell, wherein the signal is designed to pass through the outer shell; and
picking up the signal by means of a second transmitter arranged on an outer side of the outer shell.

The invention will be explained in greater detail hereinafter by way of example with reference to the accompanying drawings, in which:

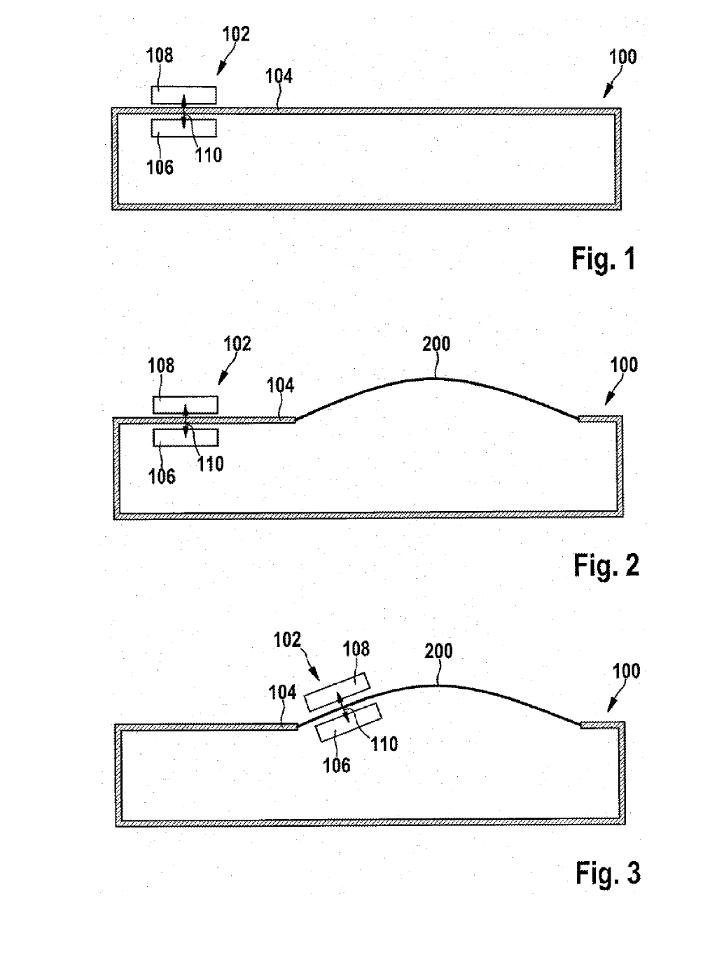

FIG. 1 shows an illustration of a battery cell with a device for transmitting an information item in accordance with an exemplary embodiment of the present invention;

FIG. 2 shows an illustration of a further battery cell with a device for transmitting an information item in accordance with a further exemplary embodiment of the present invention;

FIG. 3 shows an illustration of a further battery cell with a device for transmitting an information item in accordance with an exemplary embodiment of the present invention;

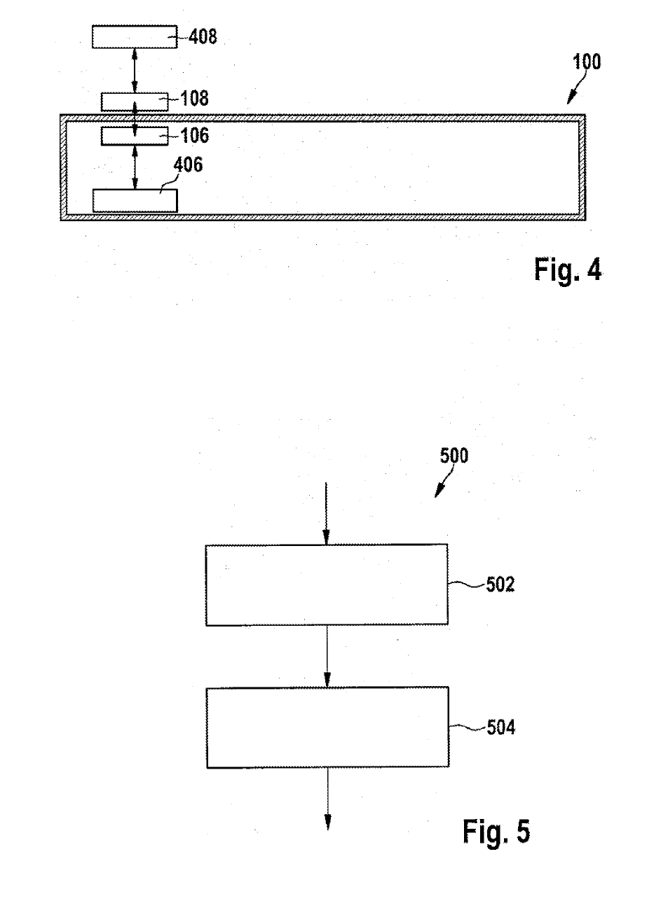

FIG. 4 shows an illustration of a further battery cell with a device for transmitting an information item in accordance with an exemplary embodiment of the present invention; and

FIG. 5 shows a flow diagram of a method for transmitting an information item from a battery cell in accordance with an exemplary embodiment of the present invention.

In the following description of preferred exemplary embodiments of the present invention, like or similar reference signs are used for the similarly acting elements illustrated in the various figures, wherein the description of these elements is not repeated.

FIG. 1 shows an illustration of a battery cell 100 with a device 102 for transmitting an information item in accordance with an exemplary embodiment of the present invention. The battery cell has an outer shell 104 with a cross section that is rectangular, for example.

The device 102 has a first transmitter 106 and a second transmitter 108. The first transmitter 106 is arranged on an inner side of an outer wall 104 of the battery cell 100. The second transmitter 108 is arranged directly opposite the first transmitter 106 on an outer side of the outer wall 104. In this exemplary embodiment, the transmitters 106, 108 are formed as flat plate-shaped bodies, which bear tightly against the outer wall 104 of the battery cell 100. The transmitters 106, 108 are electrically insulated from the outer wall 104. The transmitters 106, 108 are galvanically isolated from one another. The transmitters 106, 108 are designed to send and to receive signals 110. The signals 110 are designed to pass through the outer wall 104. The outer wall 104 is formed without interruption, at least in the region of the transmitters 106, 108.

FIG. 2 shows an illustration of a further battery cell 100 with a device 102 for transmitting an information item in accordance with a further exemplary embodiment of the present invention. The battery cell 100 and the transmission device 102 corresponds to the battery cell 100 in FIG. 1. In addition, the outer wall 104 of the battery cell 100 has a recess, in which a rupture membrane 200 is arranged. The rupture membrane 200 is thinner than the rest of the outer wall 104 and is designed to delimit the battery cell 100 in the region of the recess. The rupture membrane 200 is thus part of the outer shell, which surrounds the battery cell 100 and is formed from the outer wall 104 and the rupture membrane 200. The rupture membrane 200 is designed to compensate for volume changes of a content of the battery cell 100 by means of resilient deformation. If the volume change is too great, the rupture membrane 200 is designed to tear so as to relieve an overpressure in the battery cell 100. The transmitters 106, 108 are arranged on the outer wall 104 outside the rupture membrane 200.

FIG. 3 shows an illustration of a further battery cell 100 with a device 102 for transmitting an information item in accordance with a further exemplary embodiment of the present invention. The battery cell 100 corresponds to the battery cell 100 in FIG. 2. In contrast to FIG. 2, the transmission device 102 is arranged in the region of the rupture membrane 200. The rupture membrane 200 is thus arranged between the first transmitter 106 and the second transmitter 108. Since the rupture membrane 200 is thinner than the rest of the outer wall 104, the rupture membrane 200 has a lower resistance for the signals 110 to be transmitted compared with the exemplary embodiment shown in FIG. 2.

The exemplary embodiments shown in FIGS. 1 and 2 can be combined. By way of example, the battery cell 100 may have two transmission devices 102, wherein one of the devices 102 is arranged in the region of the membrane 200 and the other of the devices 102 is arranged in the region of the outer wall 104.

Exemplary embodiments of the present invention will be described hereinafter in greater detail with reference to FIGS. 1 to 3.

The two transmitters 106, 108 can be arranged on any point of the wall 104, 200 of the battery cell 100, that is to say also on the rupture membrane 200 of the battery cell 100.

The transmitter 106 on the inner side of the cell 100 and the transmitter 108 on the outer side of the cell 100 can be coupled either inductively or capacitively. In the case of capacitive coupling, the transmitters 106, 108 can be formed as a plate of a plate capacitor.

In the case of inductive coupling, the transmitters 106, 108 can be formed as a coil. The transmitters 106, 108 can be attached either at any point of the wall 104 or can be attached on a rupture membrane 200 provided. The coupling can be achieved either through a conductive cell wall 104 or a conductive rupture membrane 200, for example made of metal, such as aluminum, or can be achieved through a non-conductive insert in the cell wall 104 or through a non-conductive rupture membrane 200. For example, plastic can be used as a non-conductive material.

In the case of capacitive transmission through the conductive wall 104 or membrane 200, the transmission occurs by charge transfer. The transmitter 106, 108 on one side generates a charge transfer in the wall 104 or the membrane 200 by means of a voltage applied to said transmitter, and the charge transfer in turn causes a detectable charge transfer in the second transmitter 108, 106. In the case of capacitive coupling through a non-conductive wall 104 or membrane 200, the transmitter 106 on the inner side and the transmitter 108 on the outer side form a plate capacitor.

In the case of inductive coupling through a conductive wall 104 or membrane 200, a transmitter 106, 108 generates a magnetic field, and thus eddy currents, or an opposing field in the wall 104 or membrane 200.

This opposing field is detected by the second transmitter 106, 108 by means of a coil. In the case of inductive coupling through a non-conductive wall 104 or membrane 200, the coils of the two transmitters 106, 108 can form a direct inductive coupling.

FIG. 4 shows an illustration of a further battery cell 100 with a transmission device in accordance with a further exemplary embodiment of the present invention. The transmission device can be embodied and arranged in accordance with the exemplary embodiments described in FIGS. 1 to 3. The battery cell 100 has a sensor 406, which is arranged inside the battery cell, in a region surrounded by the outer shell of the battery cell 100. The first transmitter 106 is coupled to the sensor 406, for example via an electrical line. The first transmitter 106 may also be part of the sensor 406, or vice versa. A control device 408 is arranged outside the battery cell 100. The second transmitter 108 is coupled to the control device 408, for example via an electrical line.

In order to transmit an information item from the sensor 406 to the control device 408, the sensor 406 is designed so as to transmit the information item to the first transmitter 106. The first transmitter 106 is designed to convert the information item into a signal with use of suitable transmission technology and to emit the signal to the second transmitter 108. The second transmitter 108 is designed to receive the signal and to emit said signal to the control device 408 directly or as an information signal processed by means of suitable receiving technology. The control device 408 is designed to process the signal or the information signal received from the second transmitter 108 in order to obtain the information item.

In order to transmit a further information item from the control device 408 to the sensor 406, the control device 408 is designed to transmit the further information item to the second transmitter 108. The second transmitter 108 is designed to convert the further information item into a further signal with use of suitable transmission technology and to emit the further signal to the first transmitter 106. The first transmitter 106 is designed to receive the further signal and to emit said signal to the sensor 406 directly or as a further information signal processed by means of suitable receiving technology. The sensor 406 is designed to process the further signal or the further information signal received from the first transmitter 106 so as to obtain the further information item.

Due to the transmission method, a sensor signal 110 can be transmitted through a battery cell wall to the control device 408 by means of inductive or capacitive coupling. It is therefore not necessary to detect values for voltage and temperature of the battery cell 100 by means of externally applied sensors. Instead, an internally applied sensor 406 can be used.

For example, measured values that are detected by the at least one sensor 406 placed within the battery cell 100 can be sent through the wall of the cell 100 to the control device 408 by means of the transmitters 106, 108. To this end, data are transmitted through the cell wall by means of inductive or capacitive transmitters 106, 108.

Due to the approach presented here, the sensor 406 can be placed within a battery cell 100 without the need for a (costly) feedthrough through the cell wall. The signals of many sensors 406 arranged in one or in more battery cells can be guided via a single line to the control device 408. The transmission sustains particularly low loss if the sensor 406 is already attached, for other reasons, on the rupture membrane.

In accordance with an exemplary embodiment, the sensor 106 and the transmitter 106 can be separate structural elements on the inner side of the cell 100, which for example are connected by cables or conductive tracks on a common circuit board. Alternatively, the sensor 406 and the transmitter 106 can be integrated in a package or even in the same chip. The transmitter 108 on the outer side may be a purely passive structural element, for example a coil or a plate, which is attached to a cable leading to the control device 408. An active element may also be arranged between the transmitter 108 and cable in order to amplify the signal. Alternatively, it is possible to dispense completely with an explicit outer transmitter component. In this case, merely a cable can be guided as a transmitter 108 to the corresponding point via the wall or rupture membrane, into which the signal of the transmitter 406 is directly coupled.

With batteries having more cells 100, a single cable can also be used instead of individual cables from each cell outer side to the control device 408, the single cable being guided along all cells 100 from the control device 408, and the signals of all sensors 406 being coupled into said cable. Here, a transmission protocol can be used that allows parallel transmission over a single cable, for example at different carrier frequencies.

In accordance with an exemplary embodiment, a number of batteries 100 can therefore be associated with one control device 408. Each battery cell 100 has at least one sensor 406 and at least one transmitter 106. An electrically conductive cable connected to the control device 408 can be guided along the outer sides of the plurality of battery cells 100. Portions of the cable arranged on the individual battery cells 100 serve as external transmitters 108. In this case the external transmitters 108 are interconnected in series.

Alternatively, each of the plurality of battery cells 100 may have a separate transmitter 108, which is connected via a separate line or separate transmission path to the control device 408.

FIG. 5 shows a flow diagram of a method 500 for transmitting an information item from a battery cell in accordance with an exemplary embodiment of the present invention. The method has an emission step 502 and a pick-up step 504. The method 500 can be performed on a device as is illustrated in FIGS. 1 to 3.

In the emission step 502, an information item to be transmitted is received and a signal representing the information item is produced and sent by means of a transmitter arranged on a side of an outer wall of the battery cell. The signal is designed to pass through the outer wall. In the pick-up step 504, the signal is received by means of a further transmitter arranged on the opposite side of the outer wall and is output for further processing, for example to a control device.

The described exemplary embodiments shown in the figures are selected merely by way of example. Different exemplary embodiments can be combined completely or in respect of individual features. One exemplary embodiment can also be supplemented by features of a further exemplary embodiment. Further, method steps according to the invention can be repeated and performed in an order other than that described.

1. A device for transmitting an information item from a battery cell, the device comprising:
a first transmitter arranged on an inner side of an outer shell of the battery cell, the first transmitter configured to emit a signal representing the information item through the outer shell; and
a second transmitter arranged on an outer side of the outer shell and galvanically isolated from the first transmitter, the second transmitter configured to pick up the signal.

2. The device as claimed in claim 1, wherein the second transmitter is configured to emit a further signal, representing a further information item, through the outer shell, and the first transmitter is configured to pick up the further signal.

3. The device as claimed in claim 1, wherein at least one of the first transmitter and the second transmitter is arranged directly on the outer shell.

4. The device as claimed in claim 1, wherein the first transmitter has a first transmission region directed to the outer shell and the second transmitter is arranged within the first transmission region.

5. The device as claimed in claim 1, wherein the first transmitter and the second transmitter are each formed as one of an inductive transmitter and a capacitive transmitter.

6. A battery cell for storing electrical energy, the battery cell comprising:
an outer shell configured to surround the battery cell; and
a device arranged on the outer shell, the device including:
a first transmitter arranged on an inner side of the outer shell, the first transmitter configured to emit a signal representing an information item through the outer shell; and
a second transmitter arranged on an outer side of the outer shell and galvanically isolated from the first transmitter, the second transmitter configured to pick up the signal.

7. The battery cell as claimed in claim 6, wherein:
the outer shell has a rupture membrane, and the device is arranged in a region of the rupture membrane.

8. The battery cell as claimed in claim 6, wherein the outer shell is electrically insulating in a region of the device.

9. The battery cell as claimed in claim 6, wherein the outer shell is electrically conductive in a region of the device.

10. A method for transmitting an information item from a battery cell, the method comprising:
emitting a signal representing the information item with a first transmitter arranged on an inner side of an outer shell of the battery cell, the signal configured to pass through the outer shell; and
picking up the signal with a second transmitter arranged on an outer side of the outer shell.

11. The device as claimed in claim 1, wherein the second transmitter has a second transmission region directed to the outer shell and the first transmitter is arranged within the second transmission region.

12. The device as claimed in claim 4, wherein the second transmitter has a second transmission region directed to the outer shell and the first transmitter is arranged within the second transmission region.
